(19) United States
(12) Patent Application Publication
(10) Pub. No.: US 2014/0372488 A1
(43) Pub. Date: Dec. 18, 2014

(54) GENERATING DATABASE PROCESSES FROM PROCESS MODELS

(71) Applicants: Daniel Ritter, Heidelberg (DE); Christian Mathis, Wachenheim (DE)

(72) Inventors: Daniel Ritter, Heidelberg (DE); Christian Mathis, Wachenheim (DE)

(73) Assignee: SAP AG, Walldorf (DE)

(21) Appl. No.: 13/916,911

(22) Filed: Jun. 13, 2013

(51) Int. Cl. G06F 17/30

(52) U.S. Cl. CPC G06F 17/30312
USPC 707/812

(57) ABSTRACT

Methods and systems for generating and executing a database process are described. One example method includes identifying a database process within a database, the database process being generated based on an identified process model and including one or more procedures, an input location, an output location, and execution instructions configured to control execution of the one or more procedures, identifying a data set in the input location, the data set representing data to be processed by the database process, processing the data set within the database by each of the one or more procedures of the database process according to the execution instructions, and storing a result of the database process in the output location.

### TECHNICAL FIELD

The present disclosure involves systems, software, and computer-implemented methods for generating and executing a database process.

### BACKGROUND

Generally, software applications may execute on dedicated application servers. In some cases, the software applications may execute queries against external databases, for example, to select data sets to process. The data sets are generally sent over a network connecting the application server to the database. The software applications may perform some processing on the data set and may insert results corresponding to the data set back into the database, again by sending the results over the network to the database.

### SUMMARY

In general, one aspect of the subject matter described in this specification may be embodied in systems and methods performed by data processing apparatuses that include the actions of identifying a database process within a database, the database process being generated based on an identified process model and including one or more procedures, an input location, an output location, and execution instructions configured to control execution of the one or more procedures, identifying a data set in the input location, the data set representing data to be processed by the database process, processing the data set within the database by each of the one or more procedures of the database process according to the execution instructions, and storing a result of the database process in the output location.

Details of one or more implementations of the subject matter described in this specification are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1 is a block diagram illustrating an example environment for generating and executing a database process.

FIG. 2 is a block diagram illustrating an example system including a process and a corresponding database process.

FIG. 3 is a flowchart illustrating the definition, compilation, and generation of a database process.

FIG. 4 is a block diagram of an example database process including various components.

FIGS. 5A and 5B are a block diagram illustrating a system including an example process model and a corresponding database process.

FIG. 6 is a flowchart illustrating an example method for executing a database process.

FIG. 7 is a flowchart illustrating an example method for generating a database process.

### DETAILED DESCRIPTION

The present disclosure involves systems, software, and computer-implemented methods for generating and executing a database process.

As modern applications become increasingly data intensive, loading application data from a database into an application system for processing becomes more and more of a performance bottleneck. Network transport of data back and forth between applications and databases uses a significant amount of time and resources. Further, as databases provide more advanced and faster processing capabilities, application developers seek to not only store data in databases, but to push their business logic into the database to leverage the processing capabilities and to execute logic close to the data. That means application programs or algorithms that were implemented in higher-level languages such as Advanced Business Application Programming (ABAP), Business Process Modeling Notation (BPMN), or Business Process Execution Language (BPEL) are now expressed in database-specific languages like Structured Query Language (SQL) or SQL Script.

Some of these applications or some parts of these applications operate on data in a process-like manner. Data may be manipulated by a series of processing steps. For example, a processing step may apply application semantics to the data (e.g., aggregation, content-based routing, mapping, user-defined logic, etc.). The processing step may then forward its results to the next processing step.

Database systems provide declarative or functional programming languages that do not support these application processes and their development lifecycle out of the box (e.g., model, deploy, test). The systems may also lack common features of state-of-the art languages, such as modularization, versioning, extensibility or injection of custom code, and code optimizations for parallelization. Such features may be desired or required by developers of enterprise-level software. This leads to a situation, where application developers build code for process-oriented applications within a database manually, which is a time-consuming, error-prone, and expensive task that often only covers parts of the problem.

In some implementations, the present solution provides a process-oriented, visual and declarative programming model for database applications. Using this programming model, an application developer can define the application semantics as an application process using a standard process description language, such as, for example, BPMN or ABAP. The process may then be compiled to a database process that reflects the processing steps and runs inside a database system, as opposed to a separate application server. The database process can directly access the data stored in the database without the need for a system-boundary traversal. The processing steps can be enriched with application semantics using declarative and procedural SQL code. This code may be executed inside the database system as part of the database-internal process execution. Process execution may leverage well-established database features such as, for example, transactional data processing, high-availability, scalability, automatic optimization and parallelization.

In some implementations, the present solution may generate a database process corresponding to a process model specified in a standard process description language. The generated database process may include one or more procedures, which may be defined as stored procedures within the database. The process may also include an input location (e.g., a table, a set of tables, or a stored procedure) into which a data set may be placed in order to begin execution of the database process. In some cases, the database process may poll the input location for a new data set. The database process may also be executed by a trigger that is executed when data is inserted into the input location. Execution instructions may also be defined to control how data is passed between the one or more procedures of the database process when the process is executing. For example, in a database process including stored procedures A and B, the execution instructions may state that the data set from the input location is first processed by stored procedure A, which then passes its output to stored procedure B as input. The database process may also include an output location (e.g., a table, a set of tables, or a stored procedure) into which results of the database process are stored at the conclusion of processing. In some cases, a routine wishing to call the database process may insert a data set into the input location and poll the output location for the result of the process.

The present solution may provide several potential advantages. Higher performance may be achieved using the described techniques than in a standard configuration in which a process runs on an application server and loads data to and from the database. For data-intensive processes or processes that query the database often while executing, such performance gains may be even greater. Security, robustness, fail-over, and scalability features of a database management system may also be leveraged. The present solution may also simplify the process of developing database processes by allowing developers to develop processes using familiar languages and mature development tools, rather developers being constrained to develop only in languages supported natively by the database. Database processes may also be appropriate to more naturally model business applications than other approaches, and may provide application logic as content, while getting software logistics, lifecycle and extensibility from the underlying database management system.

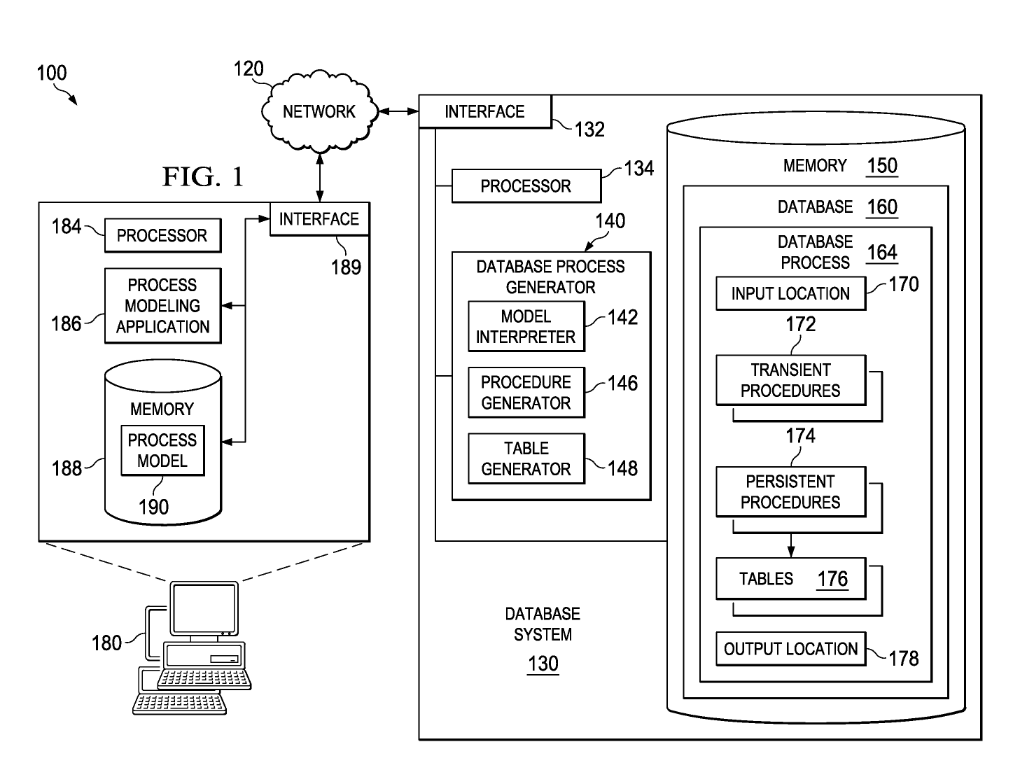

FIG. 1 is a block diagram illustrating an example environment 100 generating and executing a database process. The environment 100 includes a network 120 connecting a client 180 to a database system 130. In operation, the user of the client 180 uses a process modeling application 186 running on the client 180 to define a process model 190. The process model 190 is then sent or identified by the database system 130 and processed to produce a corresponding database process 164. The database process 164 may include transient procedures 172 and persistent procedures 174 to perform operations similar or identical to the process defined by the process model 190.

In the illustrated implementation, the example environment 100 includes a database system 130. In some implementations, the database system 130 may be a single computing device including the components shown in FIG. 1. The database system 130 may also be a set of distributed computing devices connected by a network for performing the described operations. For example, the database process generator 140 may be stored and executed on a separate computing device from the database 160.

As used in the present disclosure, the term “computing device” is intended to encompass any suitable processing device. For example, although FIG. 1 illustrates a database system 130, environment 100 can be implemented using two or more servers, as well as computers other than servers, including a server pool. Indeed, database system 130 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, illustrated database system 130 may be adapted to execute any operating system, including Linux, UNIX, Windows, Mac OS®, Java™, Android™, iOS or any other suitable operating system. According to one implementation, database system 130 may also include or be communicably coupled with an e-mail server, a Web server, a caching server, a streaming data server, and/or other suitable server.

The database system 130 also includes an interface 132, a processor 134, and a memory 150. The interface 132 is used by the database system 130 for communicating with other systems in a distributed environment—including within the environment 100—connected to the network 120; for example, the clients 180, as well as other systems communicably coupled to the network 120 (not illustrated). Generally, the interface 132 comprises logic encoded in software and/or hardware in a suitable combination and operable to communicate with the network 120. More specifically, the interface 132 may comprise software supporting one or more communication protocols associated with communications such that the network 120 or interface's hardware is operable to communicate physical signals within and outside of the illustrated environment 100.

As illustrated in FIG. 1, the database system 130 includes a processor 134. Although illustrated as a single processor 134 in FIG. 1, two or more processors may be used according to particular needs, desires, or particular implementations of environment 100. Each processor 134 may be a central processing unit (CPU), a blade, an application specific integrated circuit (ASIC), a field-programmable gate array (FPGA), or another suitable component. Generally, the processor 134 executes instructions and manipulates data to perform the operations of the database system 130. Specifically, the processor 134 may execute the functionality required to receive and respond to requests from the clients 180.

Database system 130 also includes a database process generator 140. In operation, the database process generator 140 may identify a process model 190 defined in a process definition language (e.g., BPMN, ABAP) and may generate a corresponding database process 164 from the process model 190. In some implementations, the database process generator 140 may be a software program or set of software programs executing on the database system 130. The database process generator 140 may also be an external component from the database system 130 and may communicate with the database system 130 over a network.

As shown, the database process generator 140 includes a model interpreter 142. In some cases, the model interpreter 142 may read and interpret the process model 190 in preparation for generating a corresponding database process 164. The model interpreter 142 may include support for multiple different process definition languages and may switch between these different functionalities based on the language in which the process model 190 is defined. For example, the model interpreter 142 may detect that the process model 190 is defined in the BPMN process definition language and may execute logic to interpret the statements of this language.

In some cases, the model interpreter 142 may translate the identified process model into an intermediate or neutral format specific to the database process generator 140. For example, the model interpreter 142 may read a BPMN process model definition and produce a set of internal data structures specific to the process the database process generator 140. In such a way, the database process generator 140 may take multiple process definition languages as input and may produce different types of database processes as output. For example, this configuration may enable the database process generator 140 to read a process model in ABAP and produce the database process definition in either SQL, SQL script, or any other suitable database language.

The database process generator 140 also includes a procedure generator 146. In operation, the procedure generator 146 may analyze the output of the model interpreter 142 to determine one or more stored procedures to generate to perform the processing tasks defined by the process model 190. For example, if the process model 190 defines the task of adding two integers together, the procedure generator 146 would generate a corresponding stored procedure that adds two integers together in the same manner as defined in the process model 190. In some cases, the procedure generator 146 may generate a stored procedure for each routine or objects defined in the process model 190. The procedure generator 146 may also generate multiple stored procedures for a certain object routine or block of the process model 190, such that there is not a one-to-one correspondence between elements of the process model 190 and stored procedures of the database process 164.

In some implementations, the procedure generator 146 may generate both transient and persistent stored procedures as part of the database process 164. A transient stored procedure may be a stored procedure that does not store any data in the database as it is executing, whereas a persistent stored procedure may store data in a temporary or permanent table within the database while it is executing. In some cases, the procedure generator 146 may analyze the process model 190 and generate transient and persistent stored procedures to correspond to different parts of the process model 190 based on the specific logic defined in the parts of the process model 190. For example, a portion of a process model 190 that performs an aggregation of multiple different output segments produced by the rest of a process may be implemented as a persistent stored procedure such that the aggregated result may be saved until all the output segments are received.

In the illustrated implementation, the database process generator 140 also includes a table generator 148. In operation, the table generator 148 may generate any necessary tables corresponding to the process model 190. In some cases, the table generator 148 may generate an input location table and an output location table for the database process 164, such that the database process 164 may read data to process from the input location and store results in the output location. The table generator 148 may also generate any tables necessary for execution of the persistent procedures generated by the procedure generator 146.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The database system 130 also includes a memory 150 or multiple memories 150. The memory 150 may include any type of memory or database module and may take the form of volatile and/or non-volatile memory including, without limitation, magnetic media, optical media, random access memory (RAM), read-only memory (ROM), removable media, or any other suitable local or remote memory component. The memory 150 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the database system 130. Additionally, the memory 150 may include any other appropriate data, such as VPN applications, firmware logs and policies, firewall policies, a security or access log, print or other reporting files, as well as others.

As illustrated in FIG. 1, memory 150 includes or references data and information associated with and/or related to providing the network service load control. As illustrated, memory 150 includes a database 160. The database 160 may be one of or a combination of several commercially available database and non-database products. Acceptable products include, but are not limited to, SAP® HANA DB, SAP® MaxDB, Sybase® ASE, Oracle® databases, IBM® Informix® databases, DB2, MySQL, Microsoft SQL Server®, Ingres®, PostgreSQL, Teradata, Amazon SimpleDB, and Microsoft® Excel, as well as other suitable database and non-database products. Further, database 160 may be operable to process queries specified in any structured or other query language such as, for example, Structured Query Language (SQL).

As shown, the database 160 includes a database process 164. In some cases, the database process 164 is a set of database artifacts operable to perform the same tasks defined in the process model 190. For example, if the process model 190 defines a process that splits an input string into separate words, the database process 164 may take a string as input and may output a set of words contained in the string. In some implementations, the database process 164 includes tables, stored procedures, triggers, or any other suitable database artifacts for implementing the tasks defined in the process model 190. In some cases, the database process 164 is created within the database 160 by applying instructions generated by the database process generator 140 of the database 160. For example, the database process generator 140 may generate an SQL definition of the database process 164, and the database process 164 may be created by running the statements of the SQL definition on the database 160. The database process generator 140 may also create the database process 164 directly in the database 160, such as by executing the statements of the generated definition.

As shown, the database process 164 includes an input location 170. In operation, data inserted into the input location 170 may cause the database process 164 to begin operation. The input location 170 may be a table or set of tables within the database 160. In some cases, the input location 170 may be specific to the database process 164. The input location 170 may also be a common input location for multiple database processes, such that data inserted into the input location may also specify a database process to which should be associated. In some cases, the associated database process for data inserted into the input location 170 may be identified by a unique name or identifier associated with the database process.

In some implementations, the input location 170 is polled for new data, and the database process 164 is executed when new data is detected in the input location 170. The input location 170 may also be associated with a trigger to execute the database process 164 when data is inserted into the input location 170. In some implementations, an application may request to have data processed by the database process 164 by inserting the data into the input location 170 and notifying a scheduler component (not pictured) to run the database process 164.

In the illustrated implementation, the database process 164 also includes one or more transient procedures 172. In some implementations, transient procedures 172 may be stored procedures that perform data processing without storing results in a persistent table in a location within the database. For example, transient procedures 172 may only store data in memory and not in a persistent location, such as a table while processing the data.

The database process 164 may also include one or more persistent procedures 174 associated with one or more tables 176. In some implementations, the persistent procedures 174 may store data into the associated tables 176 while processing an input data set. For example, an aggregator stored procedure may process portions of an input data set and store each processed portion in a table. After all portions have been processed, the persistent procedure 174 may insert the full result set including each of these intermediate results into an output location (e.g., 178).

In some implementations, the database process 164 may include an output location 178. The output location 178 may be a table or set of tables within the database 160 into which the database process 164 inserts results at the end of its processing. For example, a database process for breaking a string into a set of words may insert the set of words included in the string into the output location 178 at the conclusion of processing.

Illustrated client 180 is intended to encompass any computing device such as a desktop computer, laptop/notebook computer, wireless data port, smart phone, personal data assistant (PDA), tablet computing device, one or more processors within these devices, or any other suitable processing device. For example, client 180 may comprise a computer that includes an input device, such as a keypad, touch screen, or other device that can accept user information, and an output device that conveys information associated with the operation of the database system 130 or client 180 itself, including digital data, visual information, or a graphical user interface (GUI). Client 180 may include an interface 189, a processor 184, and a memory 188.

As shown, the client 180 also includes a process modeling application 186. In some implementations, the process modeling application 186 may be a graphical application the user may use to define the process model 190. The process model 190 may include a definition of the process model in any suitable process definition language or notation, such as, for example, BPMN, ABAP, or any other suitable process definition language or notation. As previously discussed, the process model 190 may be processed by the database process generator 140. In some implementations, the client 180 may provide the process model 190 to the database process generator 140. The database process generator 140 may also query the client 180 for the process model 190. In some cases, the process modeling application 186 may store the defined process model 190 in the database 160, and the database process generator 140 may read the process model 190 from there.

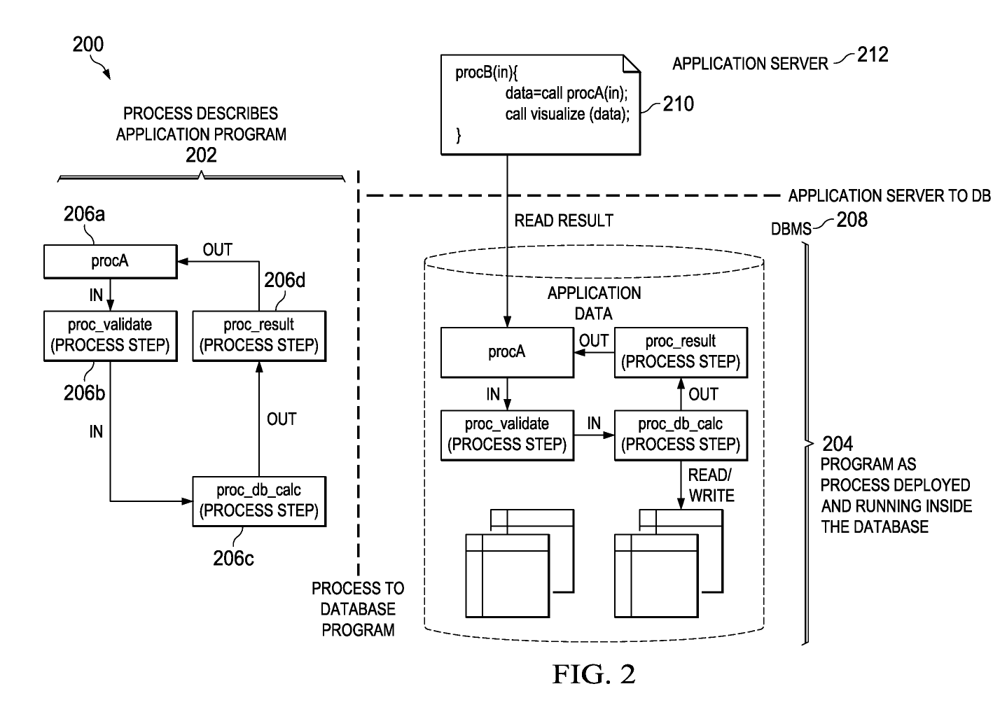

FIG. 2 is a block diagram illustrating an example system 200 including a process model 202 and a corresponding database process 204. The process model 202 includes multiple components 206a-d for performing a task associated with the process model. In some implementations, the process model 202 may be modeled by an application developer explicitly using a process definition language (e.g., BPMN, ABAP). The process model 202 may be converted, as described in FIG. 1, into database constructs (e.g., stored procedures, SQL, tables, types) to create a database process 204 inside the database system 208 that can execute the process using stored procedures and SQL. In some implementations, the complete process execution may be performed inside the database system. In some cases, an external process 210 on an application server 212 may call the database process 204 and receive results when processing is complete.

In some implementations, the system 200 may be operable to analyze application code and decompose the code into one or more process tasks (e.g., 206a-d). The system 200 may also be operable to convert the process tasks 206a-d into the database process 204 automatically.

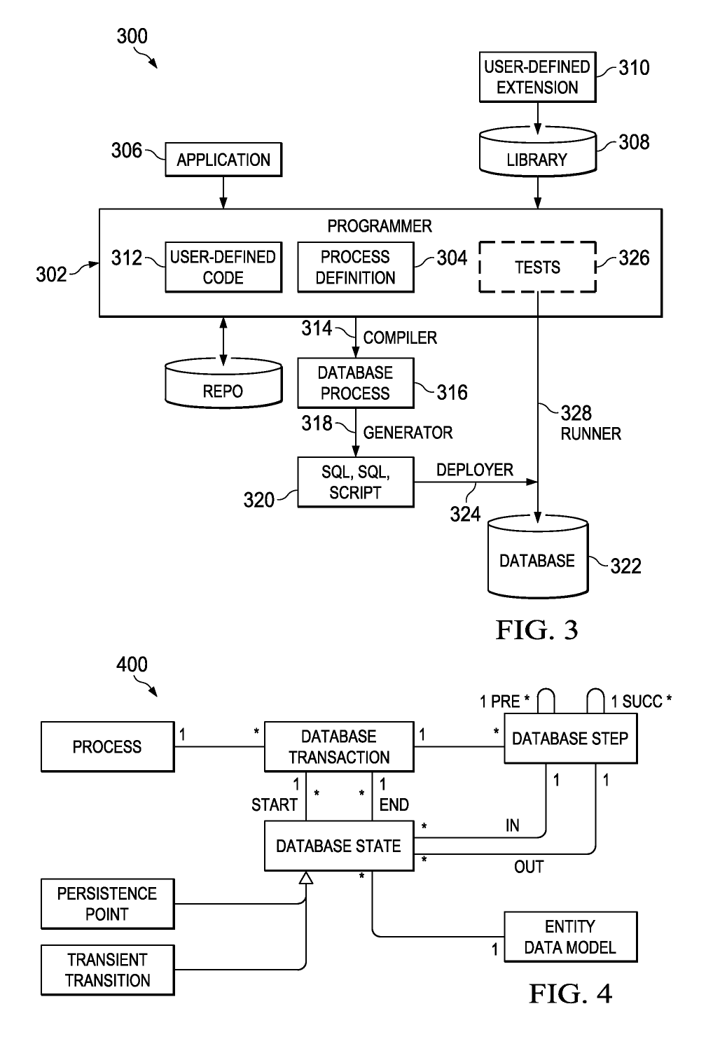

FIG. 3 is a diagram illustrating a method 300 for defining, compiling, and generating a database process. As shown, programmer 302 defines a process definition 304 according to an application 306. In some implementations, the process definition 304 may be specified using a process description language, such as, for example, BPMN, ABAP, or any other suitable language. In some cases, the process definition 304 may be generated by a visual process definition program. The programmer 302 may leverage existing process patterns from library 308 in specifying the process definition, such as, for example, filter, router, aggregation, map/reduce, loop, or any other suitable process pattern or combination of process pattern. The library can be extended by user-defined extensions 310 (patterns).

The programmer 302 may also extract/define user-defined code 312 according to the application to configure the process steps (for example, filter criteria for a filter step). The user-defined code 312 may be specified using a stored-procedure language such as, for example, SQL Script. The user-defined code 312 and the process definition 304 may then be passed to the compiler 314 which generates a database process 316. The database process 316, itself, may then be passed to a generator 318 which generates database-specific code 320 to implement a runtime on a database system 322. The deployer component 324 installs the code on the database system 322 to make it executable.

The compiler 314, generator 318, and deployer 324 form a tool chain that can be automatically invoked when some process changes. The programmer 302 may also specify tests 326 including expected input/output values and intermediate states for a given process. The tool chain may automatically evaluate the tests 326 by executing the compiler 314, the generator 318, the deployer 324 and invoking a test runner 328 component which executes the database process 316 and compares the actual results with the results specified in the test. This approach conforms to the standard model/deploy/test development cycle.

User-defined code 312, process definition 304, and tests 326 may be software artifacts that can be stored in a versioning system or repository (repo 330). In some implementations, repo 330 may be any standard versioning system or repository, including, but not limited to, GIT, Bazaar, Subversion, Concurrent Versioning System (CVS), or any other suitable system or combination of systems. Repo 330 can also be used to store common sub-processes supporting process modularization.

The present solution can be combined with other push-down approaches. A standard set of processing steps are provided (filter, router, aggregation, map/reduce, loop, etc.) for convenience. These processing steps may be configured/extended with application logic by passing SQL Script programs. Because a database process is a software artifact, support may be provided for the model/deploy/test development cycle. Based on this software artifact, process-specific support for modularization (defining and calling sub-processes), versioning (storing processes in software repositories), extensibility (defining new process step types), and optimizations for parallel processing may also be provided.

FIG. 4 is a block diagram of an example database process 400 including various components. As shown, the database process 400 includes an entity data model. Generally, a database process generated for an application process “transports” data. This means that data flows through the database process 400. Because the process is executed inside the database system, the transported data may be in relational format and thus comply with a user-defined relational model. The data that flows through a process may represents a real-world entity (for example a sales order). To reflect real-world entities in a process (and to distinguish entities from each other), the basic processing unit in a database process is an entity, which is defined by the entity data model. The entity data model may include a unique identifier (entityId) and a relational data model that specifies the data that can be transported in an entity.

Database Process

A database process may reflect some real-world process (modeled in some process modeling language like BPMN). A database process may be a bipartite, directed graph, where the set of nodes consists of persistence points and database transactions or transactions for short. The persistence points contain/store data, while the transactions contain application logic for data processing. The edges connect the persistence points with the transactions (and vice versa) and indicate data flow. All database transactions have at least one inbound and at least one outbound edge. Each persistence point has at least an inbound or an outbound edge. Each persistence point has a maximum number of 1 inbound edge and a maximum number of 1 outbound edge. Persistence points with no inbound edge are called inbound persistence points, and persistence points with no outbound edge are called outbound persistence points.

Database Transaction

A database transaction models a transition of the data stored in the database process from one consistent state to another (see Section “Transactional Processing”). In our approach, a (database) transaction is a bipartite, directed graph, where the set of nodes consists of database states (see below) and database steps (see below) or states and steps for short. The graph is connected. The edges connect the states with the steps (and vice versa) and indicate data flow. All steps have at least one inbound and at least one outbound edge. Each state has at least an inbound or an outbound edge. Each state has at most one inbound edge and at most one outbound edge. States with no inbound edge are called inbound states, and states with no outbound edge are called outbound states. The union of all inbound and outbound states is called endpoints. The endpoints of a transaction form a subset of the persistence points of the process the transaction belongs to. Let P be the persistence points of a process. Then the union of all endpoints of all transactions of the same process is also P.

Database State (Persistence Point/Transient Transition)

A database state (as above) may be either a persistence point or a transient transition. A transient transition may have one inbound edge and one outbound edge (i.e., a transient transition cannot be an endpoint and appears only internal within a transaction). A state may be described by an entity definition (entity data model). The state may correspond to a database table (in case of a persistence point) or a database type used as an in-memory (transient) parameter type of a stored procedure (in case of a transient transition). The entity data model may define the relational model of the table or type.

Database Step

A database step belongs to a transaction and contains application semantics. In some implementations, a library of application semantics may include pre-defined steps like router, filter, aggregator, loop, map/reduce, and others. Steps can be configured with application-specific (user-define) code (for example, filter conditions). A step may receive the data from some inbound state(s), processes this data and writes the result to some outbound state(s) as defined by the transaction graph.

Transactional Processing

In some implementations, database transactions may execute transactional processing by implementing the following protocol:

1. Begin a transaction.

2. Read entities from inbound states.

3. Execute steps one after the other (passing intermediate entities as transient transitions).

4. Write result entities to outbound state(s).

5. Remove (processed) entities from inbound state(s).

6. Execute database commit operation.

Code Generation

The generator may receive a database process and generates the database-specific code to run the process on a database system. The following describes the purpose of the generated code in one example implementation.

Database Process

The code generator may enumerate all the transactions of a process and generate code for them (see below).

Database Transaction

The code generator may enumerates all steps of a process and generate code for them (see below). It also may generate a stored procedure that executes the transactional processing functionality described in Section “Transactional Processing.” This procedure is also responsible to pass intermediate results as in-memory variables from one step execution to the following.

Database Step

In some implementations, the code generator enumerates the states a step is connected to and generates code for them (see below). The step itself is generated to a stored procedure. The body of the stored procedure contains the user-defined code (which is part of the step configuration, see above). The list of parameters of the procedure depends on the type of the state(s) connected to the step's inbound edge. For each state, the following is decided: If the state is a persistence point, no arguments are created because the procedure can read the data from the table that will be generated for the persistence point (see below). If the state is a transient transition, a parameter to capture the entities according to the entity data model is created. The list of return values from the procedure depends on the type of the state(s) that follow the step. For each of these states, the following is decided: If the state is a persistence point, nothing is returned (instead, the procedure directly writes the result in the table generated for the persistence point; see below). In case the state is a transient transition, the procedure returns the result as a variable.

Database State

Database states are generated to types (in case of transient transitions) or tables (in case of persistence points).

Extensions

The programmer of a process can decide to have non-persistent endpoints (in a transaction or even in a whole process). Then, the calling environment (application) is responsible for commit handling.

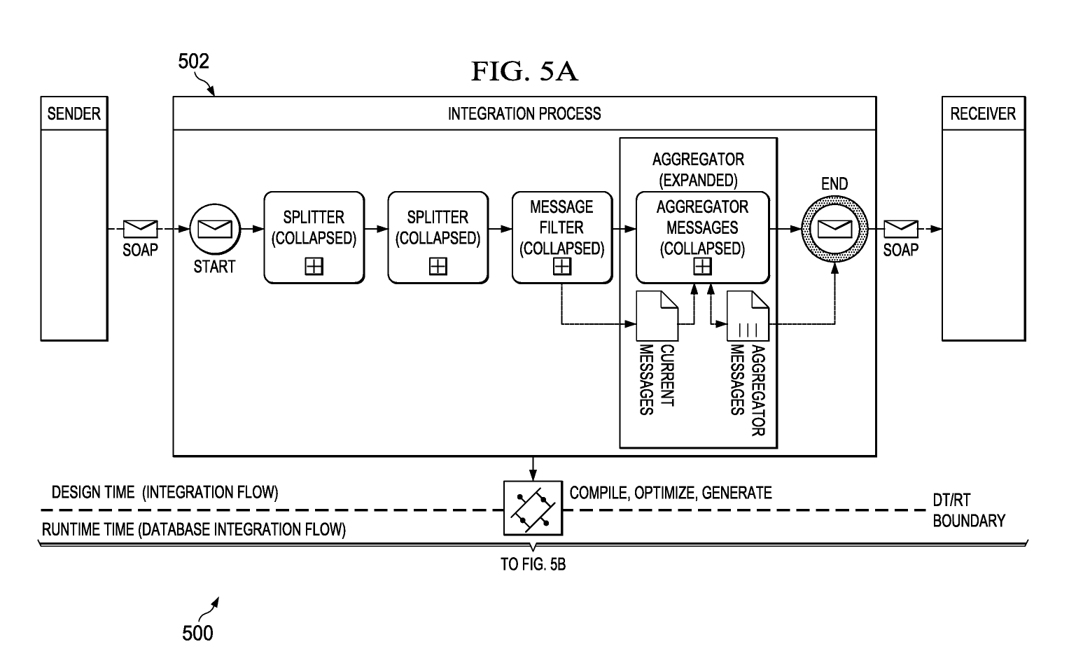

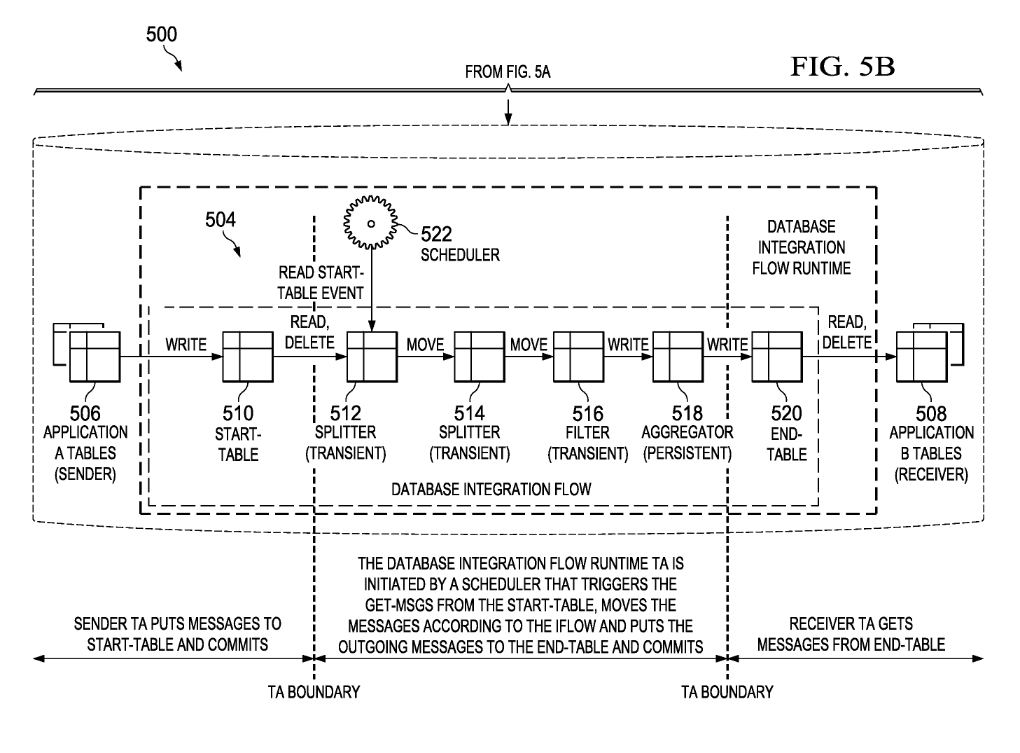

FIGS. 5A and 5B are a block diagram illustrating a system 500 including an example process model 502 and a corresponding database process 504. The system 500 shows the application of the present solution in the domain of enterprise application integration (EAI). A process model 502 is defined in a process definition language such as BPMN, ABAP, BPEL, or any other suitable language. The process model 502 implements a “Bag of Words”' (BoW) algorithm. A database process 504 corresponding to the process model 502 is generated. The system 500 also includes two applications 506 and 508 that communicate by sending messages. Application 506 may insert a dataset including text into start table 510 to begin processing by the database process 504. The text is split into sentences by the first splitter 512. The second splitter 514 splits the sentences to words. The message filter 516 removes stop words, while the aggregator 518 counts the occurrences of same words. Results of the database process 504 are placed in the end table 520 which is read by the application 508.

The endpoints may represent entry/exit points for entities into/from the process. Therefore, they may capture relational message body data and are generated by our approach as persistence points named start table 510 and end table 520. For example, application 506 may fill the start table 510 with text from its application table. The application 506 may trigger the database process 504 by invoking the scheduler 522 and informing application 508. The scheduler 522 is responsible for executing the database process 504 until all data is processed. Application 508 may then read the resulting bag of words from the end table 520.

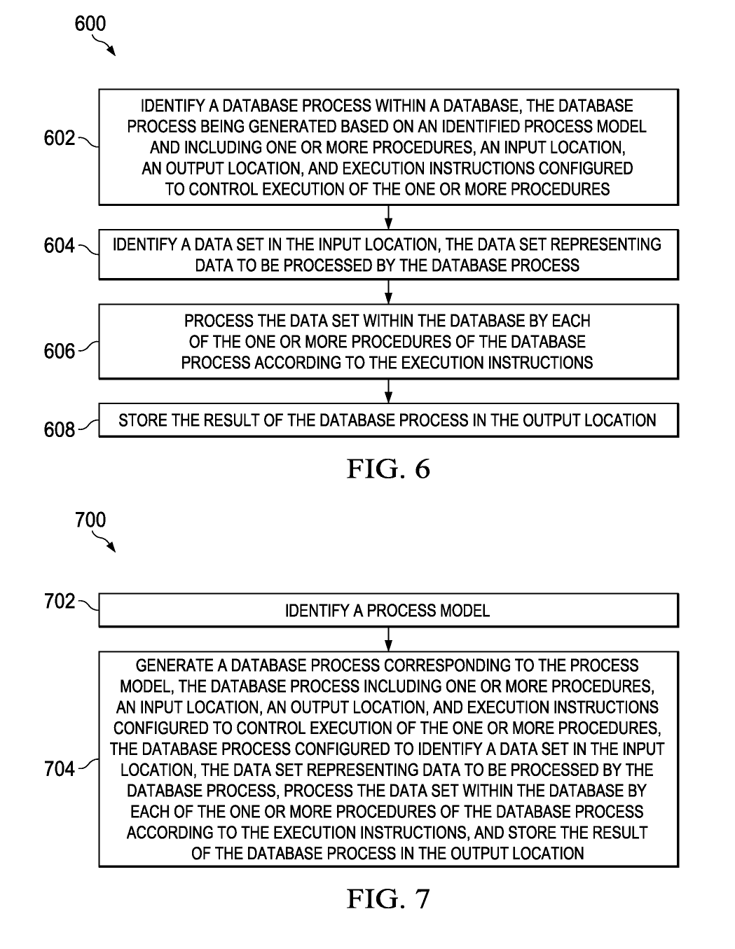

FIG. 6 is a flowchart illustrating an example method for executing a database process. At 602, a database process is identified within a database, the database process being generated based on an identified process model and including one or more procedures, an input location, an output location, and execution instructions configured to control execution of the one or more procedures. In some implementations, the database process may be identified by receiving a definition of the database process in a database-specific language such as SQL, SQL Script, or any other suitable language. The database process may also be identified by a database process generator component, such as the database process generator 140 described relative to FIG. 1. In some cases, each of the one or more procedures and the execution instructions may correspond to components defined in the identified process model. The identified process model may be specified by a developer or other user utilizing a process definition application (e.g., 186 in FIG. 1). The identified process model may also be coded manually by a developer or other user in any suitable process definition language including, but not limited to, BPMN, BPEL, ABAP, or any other suitable language.

At 604, a data set is identified in the input location, the data set representing data to be processed by the database process. As discussed previously, the data set may be identified by any suitable mechanism, including polling the input location, receiving a notification from a trigger associated with the input location, receiving a notification from a scheduler that data is present in the input location, or any other suitable mechanism.

At 606, the data set is processed within the database by each of the one or more procedures of the database process according to the execution instructions. In some implementations, the data set is processed within a database runtime associated with the database process. The data set may be processed within a transaction associated with the database process. At 608, the result of the database process is stored in the output location. In some cases, storing the result in the output location may include inserting the results into a database table associated with the database process. The inserted result may include an identifier associated with the database process or with the initial request to process the data set in cases where the output location is shared between multiple database processes.

In some implementations, a stored procedure configured to receive the data set and store the data set in the input location and configured to read the result of the database process from the output location and provide the result to a calling routine is provided. Such a stored procedure may provide an interface to the database process that is similar to a stored procedure to a calling application.

In some cases, processing the data within the database may include starting a transaction associated with the database process at the beginning of processing the data set, and committing the transaction associated with the database process at the end of processing the data set. Such a configuration may allow the database process to recover from errors during processing the data set by rolling back the transaction.

FIG. 7 is a flowchart illustrating an example method for generating a database process. At 702, a process model is identified. At 704, a database process is generated corresponding to the process model, the database process including one or more procedures, an input location, an output location, and execution instructions configured to control execution of the one or more procedures. The database process may be configured to identify the data set in the input location, where the data set represents data to be processed by the database process. The database process may be further configured to process the data set within the database by each of the one or more procedures of the database process according to the execution instructions. The database process may be further configured to store the result of the database process in the output location.

In some implementations, the execution instructions define an order in which the one or more procedures should be executed and define how data should be passed between the one or more procedures as the data set is processed. For example, the execution instructions may specify that stored procedure A of the database process should feed its output to stored procedure B as input.

In some cases, the one or more procedures may include one or more persistent procedures configured to store data in associated database tables as the data set is processed. For example, an aggregator stored procedure may store all received input in a table for the duration of the database process, and then output the full data set to the output location at the end of the database process.

The preceding figures and accompanying description illustrate example processes and computer implementable techniques. But environment 100 (or its software or other components) contemplates using, implementing, or executing any suitable technique for performing these and other tasks. These processes are for illustration purposes only and that the described or similar techniques may be performed at any appropriate time, including concurrently, individually, or in combination. In addition, many of the steps in these processes may take place simultaneously, concurrently, and/or in different order than as shown. Moreover, environment 100 may use processes with additional steps, fewer steps, and/or different steps, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method performed by one or more processors, the method comprising:
identifying a database process within a database, the database process being generated based on an identified process model and including one or more procedures, an input location, an output location, and execution instructions configured to control execution of the one or more procedures;
identifying a data set in the input location, the data set representing data to be processed by the database process;
processing the data set within the database by each of the one or more procedures of the database process according to the execution instructions; and
storing a result of the database process in the output location.

2. The method of claim 1, further comprising:
providing a stored procedure configured to receive the data set and store the data set in the input location and configured to read the result of the database process from the output location and provide the result to a calling routine.

3. The method of claim 1, wherein processing the data within the database further comprises:
starting a transaction associated with the database process at the beginning of processing the data set; and
committing the transaction associated with the database process at the end of processing the data set.

4. The method of claim 3, wherein the one or more procedures include one or more persistent procedures configured to store data in associated database tables as the data set is processed, and the one or more persistent procedures are each associated with a transaction different from the transaction associated with the database process.

5. The method of claim 1, where the input and output locations include one or more database tables.

6. The method of claim 1, wherein identifying the data set in the input location includes at least one of: polling the input location for the data set, or receiving notification from a trigger associated with the input location.

7. The method of claim 1, wherein the execution instructions define an order in which the one or more procedures should be executed, and define how data should be passed between the one or more procedures as the data set is processed.

8. The method of claim 1, wherein the identified process model is defined in at least one of: Business Process Modeling Notation (BPMN), or the Advanced Business Application Programming (ABAP) language.

9. A computer-implemented method performed by one or more processors, the method comprising:
identifying a process model; and
generating a database process corresponding to the process model, the database process including one or more procedures, an input location, an output location, and execution instructions configured to control execution of the one or more procedures, the database process configured to identify a data set in the input location, the data set representing data to be processed by the database process, process the data set within the database by each of the one or more procedures of the database process according to the execution instructions, and store a result of the database process in the output location.

10. The method of claim 9, where the input and output locations include one or more database tables.

11. The method of claim 9, wherein identifying the data set in the input location includes at least one of: polling the input location for the data set or receiving notification from a trigger associated with the input location.

12. The method of claim 9, wherein the execution instructions define an order in which the one or more procedures should be executed and define how data should be passed between the one or more procedures as the data set is processed.

13. The method of claim 9, wherein the one or more procedures include one or more persistent procedures configured to store data in associated database tables as the data set is processed.

14. The method of claim 9, wherein the process model is defined in Business Process Modeling Notation (BPMN).

15. The method of claim 9, wherein the process model is defined in the Advanced Business Application Programming (ABAP) language.

16. A system, comprising:
memory for storing data; and
one or more processors operable to perform operations comprising:
identifying a database process within a database, the database process being generated based on an identified process model and including one or more procedures, an input location, an output location, and execution instructions configured to control execution of the one or more procedures;
identifying a data set in the input location, the data set representing data to be processed by the database process;
processing the data set within the database by each of the one or more procedures of the database process according to the execution instructions; and
storing a result of the database process in the output location.

17. The system of claim 16, the operations further comprising:
providing a stored procedure configured to receive the data set and store the data set in the input location and configured to read the result of the database process from the output location and provide the result to a calling routine.

18. The system of claim 16, wherein processing the data within the database further comprises:
starting a transaction associated with the database process at the beginning of processing the data set; and
committing the transaction associated with the database process at the end of processing the data set.

19. The system of claim 18, wherein the one or more procedures include one or more persistent procedures configured to store data in associated database tables as the data set is processed, and the one or more persistent procedures are each associated with a transaction different from the transaction associated with the database process.

20. The system of claim 16, where the input and output locations include one or more database tables.
